(19) United States
(12) Patent Application Publication
(10) Pub. No.: US 2026/0219972 A1
(43) Pub. Date: Jul. 30, 2026

(54) SYSTEMS AND METHODS FOR EXCEPTION HANDLING OF ALTERNATIVE RECORDKEEPING ENTITY DATA

(71) Applicant: WELLS FARGO BANK, N.A., San Francisco, CA (US)

(72) Inventors: Pallavi Kalahasti, Pleasanton, CA (US); Rajesh Kumar Subbiah, Plymouth, MN (US)

(21) Appl. No.: 19/038,330

(22) Filed: Jan. 27, 2025

(51) Int. Cl. G06F 11/07; G06F 16/215

(52) U.S. Cl. CPC G06F 11/0703; G06F 16/215

(57) ABSTRACT

Systems and methods for exception handling of alternative recordkeeping of data files for entities are described. The systems and methods include receiving a set of files, where each file includes a set of record. Each file is merged to create a merged file including the set of records. An appended merged file is generated by, for each record in the merged file, evaluating the record syntax to determine whether the syntax is valid or invalid and assigning a corresponding syntax flag to the record, and evaluating content of the record to determine whether the content is ready for further processing and assigning a corresponding record ready flag including a record-valid or record-invalid or record partially-valid. The appended merged file is then transmitted, for instance, for further processing.

### FIELD OF INVENTION

The present disclosure generally relates to reception and management of files, and more specifically to systems and methods exception handling of alternative recordkeeping files for entities (also known as Pass Through Data for external parties).

### BACKGROUND

Per rules, regulations, computing capabilities and other internal and external factors, some computing environments may be required to receive and store improperly formatted files from external sources prior to processing the files, for instance, to provide for alternative recordkeeping. However, variations in data received from external sources can create a host of issues for the computing environment responsible for processing the files. Such risks can include loss of the alternative records and infrastructural instability of the computing environment tasked with receiving the files. Moreover, blanket acceptance of the data by the computing environment can lead to storage of non-conforming data, leading to unnecessary burdens on data storage and retrieval, thereby limiting the effectiveness of the computing environment.

### SUMMARY

According to certain examples, a method for exception handling of alternative records is described. The method includes receiving a set of files, each file of the set of files including a set of records. Each file is merged into a merged file. The method includes generating an appended merged file having various flags indicating the status of records and files within the appended merged file. The appended merged file is generated by evaluating a syntax of the record to determine whether the syntax is valid or invalid and assigning a corresponding syntax flag to the record and also evaluating content of the record to determine whether the content is ready for processing and assigning a corresponding record ready flag including a record-valid flag or a record-error flag. The method includes transmitting the appended merged file.

Another example relates to a system including one or more processors configured to perform operations. The operations include receiving a set of files, each file of the set of files including a set of records. Each file is merged into a merged file. The operations include generating an appended merged file having various flags indicating the status of records and files within the appended merged file. The appended merged file is generated by evaluating a syntax of the record to determine whether the syntax is valid or invalid and assigning a corresponding syntax flag to the record and also evaluating content of the record to determine whether the content is ready for processing and assigning a corresponding record ready flag including a record-valid flag or a record-error flag. The operations include transmitting the appended merged file.

A further example relates to a non-transitory computer readable medium comprising instructions that, when executed by one or more processors, cause the one or more processors to perform operations. The operations include receiving a set of files, each file of the set of files including a set of records. Each file is merged into a merged file. The operations include generating an appended merged file having various flags indicating the status of records and files within the appended merged file. The appended merged file is generated by evaluating a syntax of the record to determine whether the syntax is valid or invalid and assigning a corresponding syntax flag to the record and also evaluating content of the record to determine whether the content is ready for processing and assigning a corresponding record ready flag including a record-valid flag or a record-error flag. The operations include transmitting the appended merged file.

These illustrative aspects and features are mentioned not to limit or define the presently described subject matter, but to provide examples to aid understanding of the concepts described in this application. Other aspects, advantages, and features of the presently described subject matter will become apparent after review of the entire application.

### BRIEF DESCRIPTION

A full and enabling disclosure is set forth more particularly in the remainder of the specification. The specification makes reference to the following appended figures.

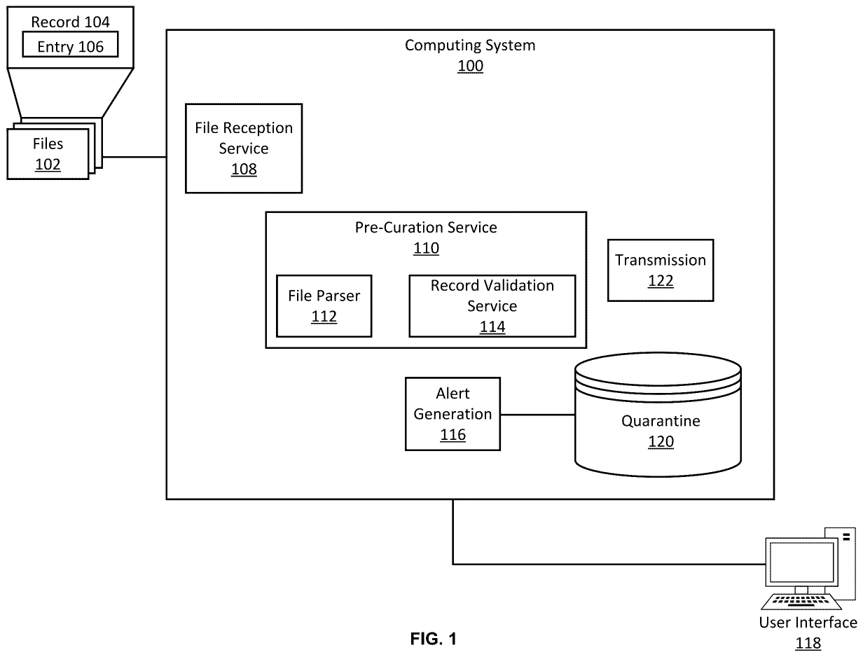

FIG. 1 shows a system for improved record processing, according to certain embodiments.

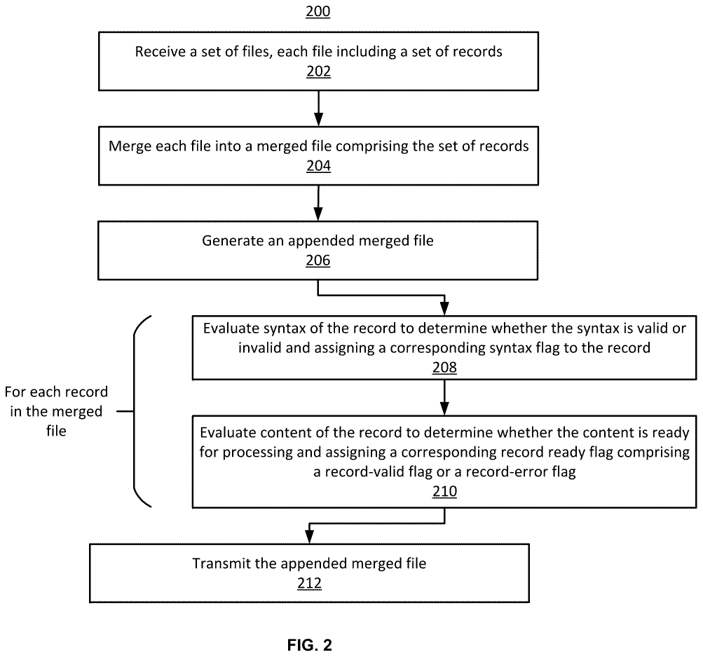

FIG. 2 shows an example process for handling exceptions within records, according to certain embodiments.

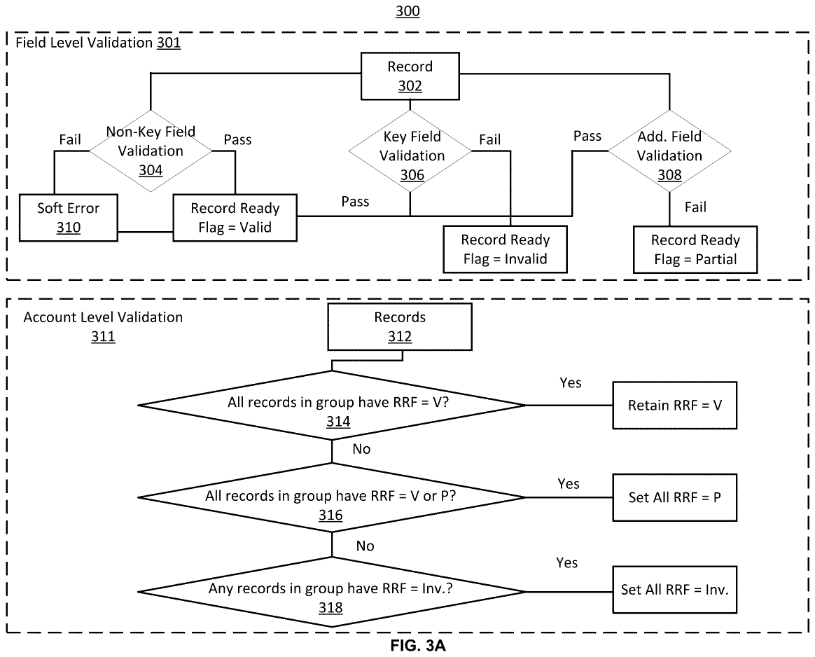

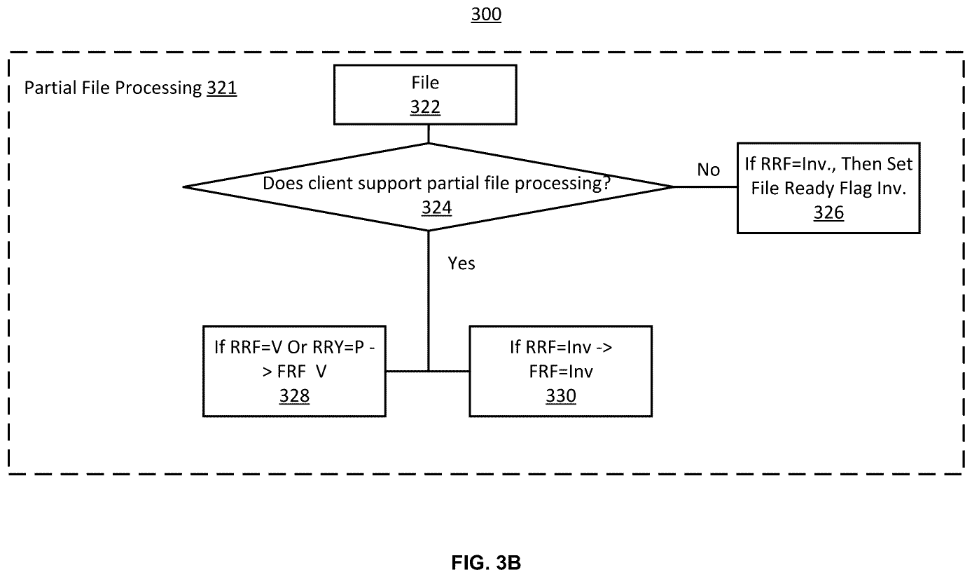

FIGS. 3A and 3B show an example process for appending files and records within files to facilitate record validation, according to certain embodiments.

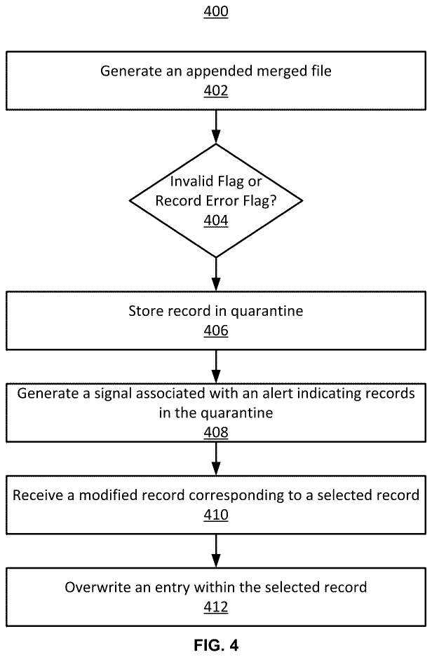

FIG. 4 shows an example process for quarantining and remedying improper records, according to certain embodiments.

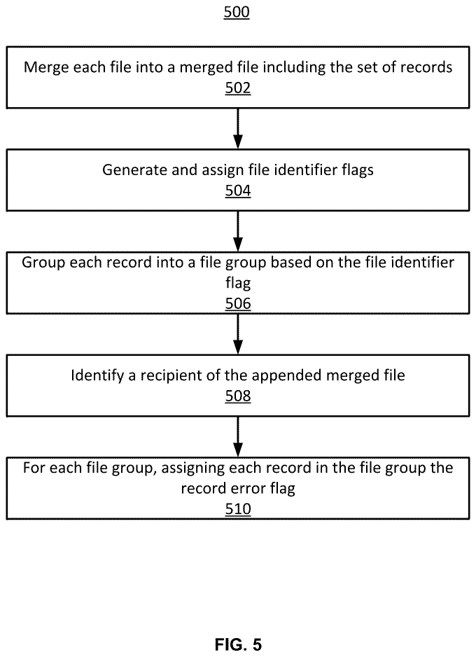

FIG. 5 shows an example process for merging files, allowing for record exception handling, according to certain embodiments.

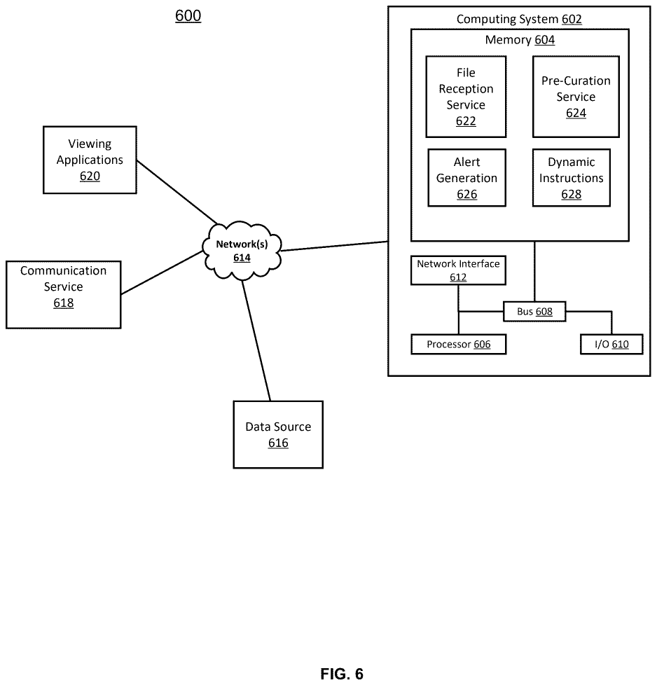

FIG. 6 shows a block diagram for an example computing environment capable of executing the described systems and methods, according to certain examples.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Example of Alternate Record Exception Handling

In one illustrative example, a record processing system is described, providing means for receiving and managing files received from external to the computing environment. The files received, referred to as third party files, may be received in a variety of raw and delimited formats, where the variation in file standards prevents the efficient, uniform processing of such files. For instance, the federal deposit insurance corporation's (FDIC) Rule 370 imposes alternative recordkeeping requirements which requires the management and storage of third party files, allowing third parties to input files and records in a variety of formats. However, the variety of formats can result in errors in subsequent processing or impose significant processing costs on the system responsible for further processing.

In part to overcome the issues associated with alternative recordkeeping, the described system allows servicers of the computing network to manage the processing of such files and records in an efficient manner while allowing applications to scale. It further provides guardrails for file acceptance from third parties which otherwise do not conform to system requirements and guidelines, such as FDIC Rule 370.

According to the illustrative example, a record processing system is capable of receiving third party files from a variety of sources including various network attached repositories. Each file can include a set of records linked to various entities. Each record of the set of records can include various entries requiring further analysis to ensure that the associated records are ready for further processing and otherwise do not violate various computing and legal requirements.

In the illustrative example, prior to validating the records received within the third party files, the record processing system can merge the files under a single large file approach. Contrary to previous approaches which have assumed divided records equates to more efficient processing (i.e., “slicing and dicing” processing), merged file approach can be applied prior to further processing and validation in order to minimize process initialization and “start-up” time requirements.

Once the third party files are merged, the merged file can be evaluated per parsing procedures to ensure each record is readable. The file format check can thus provide a first stage of file curation (or pre-curation when accounting for subsequent processing procedures applied to the alternative records when they are otherwise correctly stored). If a given record fails the parsing procedures (i.e., is not readable due to errors or mis-entries within a given entry), then alerts and notifications can be generated and transmitted to the relevant computing systems including those belonging to the relevant lines of business and/or to those of regulators.

In a second stage of processing the merged file, various file and record validation procedures can be applied to systematically determine whether a record or file is ready for subsequent processing. Field level validation and account level validation procedures can be applied. At the field level, field entries within a given record can be evaluated, including non-key fields, and key fields (e.g., customer key fields and participant key fields). Records with errors in non-key fields can have error capture flags set accordingly, while records in key fields can cause record ready flags to be appropriately set in the appended merge file. At the account level validation stage, records can be grouped (e.g., based on an account group), and the record ready flags for each record in the group can be adjusted per specific validation procedures. Additional validation procedures, including how record ready flags are set, are discussed according to the various examples described further throughout the detailed description.

Similar to the parsing procedures, files and records that fail respective validation procedures can result in alerts and notifications generated and transmitted to the relevant computing systems. Additionally, the invalid files and records can be stored or otherwise linked within a quarantine repository for further review. Thus, alerts and notifications indicating invalid files and records can point to and provide access to the quarantine repository with respect to a given computing system's access permissions. Then, relevant users can proceed to the quarantine repository to be provided an opportunity to cure any deficient files and records.

Files and records otherwise determined to be valid (i.e., with record ready flags set to true), can then be stored or transmitted for subsequent processing. For instance, the file and record parsing and validation procedures described above may relate to a pre-curation procedure, where such data is initially processed. However, absent such initial processing, subsequent processing procedures, such as file and record curation, may be prevented from proper functioning, leading to file mismanagement, data loss, regulatory non-compliance, and other significant issues in electronic database management and data processing.

### Example Computing System for Alternate Record Exception Handling

FIG. 1 shows a system for improved record processing, according to certain embodiments. The embodiments according to FIG. 1 are shown to illustrate the logical and physical implementation of the alternative recordkeeping and exception handling system according to certain embodiments. Other embodiments, however, are possible. For instance, certain components may be shown as distinct components to illustrate the progression of the data flow, while according to some embodiments, the physical implementation of such components may be implemented across the same device (e.g., the quarantine repository may be illustrated to provide a logical separation, while otherwise being within the same physical storage as other data)It is to be appreciated that the example embodiments according to FIG. 1 are provided for illustrative purposes. Examples of implementations of the computing system 100 capable of implementing the described embodiments of FIG. 1 are discussed further with respect to the computing system of FIG. 6.

The computing system 100 includes a file reception service 108 for receiving files 102 from external to the computing system 100. The file reception service 108 can store the files 102 in various repositories within the computing system 100 for subsequent retrieval and processing, or can receive files 102 from external to the computing system 100 for immediate processing. The files 102 received (also referred to as third-party files), can originate from a variety of third party sources where each source may have its own procedures and file formatting, which can result in inconsistent files received by the file reception service 108, requiring subsequent analysis per a pre-curation service 110, including a file parser 112 and record validation service 114 respectively.

The files 102 are shown to include records 104, where each record includes entries 106. The records 104 pertain to an entity (i.e., a person, organization, or the like), and thus comprise entries 106 identifying the corresponding entity, in addition to further information associated with the entity. For instance, entries 106 can include data related to entity status, credits and in the example case related to FDIC Rule 370 operations, entity finances.

The file reception service 108 can perform merge procedures in order to generate a merged file including a set of files 102. In performing the merge procedures, the file reception service 108 can generate and assign a file identifier flag for each record, denoting its corresponding file 102 prior to merging the records of the set of files being merged. Thus, the file 102 corresponding to the record 104 can be subsequently identified and retrieved for prompting to users when a given record fails parsing procedures or record validation. Grouping files 102 based on file identifier flags can also allow for partial file processing procedures, discussed with respect to FIG. 3B.

The merged file, containing a set of files 102, may then be processed per a pre-curation service 110 including a file parser 112, record validation service 114. The pre-curation service 110 can generate an appended merged file, where the appended merged file includes flags and errors indicative of issues requiring resolution within the merged file and constituent files 102. Such issues may then be resolved prior to subsequent transmission 122 of the appended merged file or constituent records. Compared to processing of each file 102 individually within a loop, processing of the merged file was found to take substantially less time. Thus, generation of the merged file, per the file reception service 108, can provide an initial means of streamlining the file 102 and record 104 parsing and evaluation process.

File parser 112 can include instructions, which when executed, cause the computing system 100 to determine whether a given record is readable. Example operations can include format checking, null value identification, and compliance with a given file size or other metadata evaluation such as file type evaluation. The file parser 112 can reject files and/or log errors within files. For instance, if a given entry fails parsing, a flag may be set for the entry and for the record containing the entry. Additionally or alternatively, flags can be set for the file (as linked within the merged file) which contained the record with the non-readable entry. Such respective flags can be used by the computing system 100 to provide different levels of notifications and alerts transmitted back to a given user device, in addition to different levels of control applied to subsequent filtering of the merged file.

For instance, if a given entry, record, or file, is flagged as non-readable or otherwise not properly parsed, the file parser 112 can transmit the corresponding record or file to a quarantine repository 120. Additionally or alternatively, per an alert generation module 116, signals associated with the display of an alert or other notification can be generated and transmitted to various user interfaces 118 and devices, such as the devices associated with a line of business responsible for the given file or records'management.

The computing system 100 includes a record validation service 114 for performing quality-check level analysis of files 102, records 104, and entries 106. Generally, the record validation service 114 includes instructions for causing the computing system 100, to analyze files 102 and records 104 for proper content formatting as opposed to general readability (as analyzed per file parser 112). Each individual entry, and combinations of entries within a given record 104 can be evaluated according to various validation procedures described further according to the examples of FIGS. 2 and 3A-3B. For example, soft-errors can be detected and flagged. Soft-errors indicate discrepancies within records which still allow for the subsequent calculations and processing (e.g., calculations within the FDIC Rule 370 framework). In response to soft-errors (corresponding flags may be appended to the record and/or file containing the record. Similarly, in response to identified hard-errors (e.g., errors that do render the record non-compliant per subsequent computer processing requirements, or non-complaint with respect to various regulations) can lead to the record validation service 114 appending corresponding record ready flags to the record or file ready flags to the associated file.

Like operations executed by the file parser 112, files and records analyzed per the record validation service 114 can lead to storage in the quarantine repository 120, and messages and alerts generated by the alert generation module 116. Thus, if records or files are flagged as unready for further processing, or if they are flagged with soft-errors, such errors and flags can be transmitted back to the relevant parties'user interfaces. FIG. 4 describes further example operations of the alert generation module 116 tied to a quarantine repository 120.

Depending on the flags set by pre-curation service 110, the computing system 100 may proceed with further storing the processed merged file, or transmitting the processed merge file. The computing system 100 is shown including a transmission operation 122 which can represent transmission of the file for further processing. According to some examples, transmission 122 can refer to transmission to a curation service, where the curation service can process the pre-curated files and records for subsequent transmission or storage in various databases. However, through implementation of the operations performed by the pre-curation service 110, files and records may be validated and corrected prior to transmission 122 or curation, allowing for more seamless processing of the validated records and files.

### Example Process for Record Exception Handling

FIG. 2 shows an example process for handling exceptions within records, according to certain embodiments. For illustrative purposes, the process 200 is described with reference to implementations described above with respect to one or more examples described herein. Other implementations, however, are possible. In some aspects, the operations in FIG. 2 may be implemented in program code that is executed by one or more computing devices such as the computing system 100 of FIG. 1. In some aspects of the present disclosure, one or more operations shown in FIG. 2 may be omitted or performed in a different order. Similarly, additional operations not shown in FIG. 2 may be performed.

At block 202 the process 200 includes receiving a set of files, each file of the set of files including a set of records. The set of files can generally include third party files, or files received from external the computing system 100 and computing environment. In an example case, the files received can arrive from various third party providers, varying in format, size, and followed procedures. For instance, different third parties may follow different file transmission protocols, and automated processes for file and record management. As a result, the received third party files can vary in format and lack standardization, rendering it difficult to provide for proper accounting and recordkeeping of the underlying records within the third party files.

At block 204 the process 200 includes merging each file of the set of files into a merged file including the sets of records. All third party files received, or a subset of files received can be merged to create the merged file. In some cases, different merged files can be created to account for variance in timing of when the third party files are received. For instance, a first merged file can be created to account for all third party files received within a first time period (e.g., a 24 hour window), while a second merged file can be created for a second time period. While conventional processes for record management have relied on separate, parallel processing of individual files, the merged approach has been found to drastically reduce file processing per subsequent procedures, for instance, in avoiding startup times required with separate instantiation of each file.

Generally, the merged files can be those of the same format and encoding, though merging generally can include a process of merging files with varying formats. For example, ASCII files may be merged into the same merged file and Extended Binary Coded Decimal Interchange Code (“EBCDIC”) files may be merged into another merged file. Because file management and error reporting may be done on a file-by-file basis it may be beneficial to maintain tracking of each file subsequently added into the merged file. Additional techniques for managing the tracking and recordation of the constituent set of files within the merged file are discussed with respect to FIG. 5.

At block 206 the process 200 includes generating an appended merged file. The appended merged file includes each file and can further include additional data appended to each record within each file. The additional data, or metadata, can include flags and error codes which indicate the health and status of each record, such as record-ready flags and soft-error flags. The flags and error codes can be used to debug a given record or file, and can further control whether a record, or the file to which the record belongs, is ready for further processing. Blocks 208 and 210 illustrate techniques by which the merged file is appended. Blocks 208 and 210 may be performed as executable instructions stored within the file parser 112 and record validation service 114 respectively, collectively referred to as executable instructions within the pre-curation service 110.

Blocks 208 and 210 illustrate means by which the appended merged file is generated. Blocks 208 and 210 are bracketed to illustrate that the appending process, as generally outlined per block 206, can be performed for each record in the merged file. Alternatively, according to some examples, only a subset of records in the merged file may be processed per blocks 208 and 210. Block 208 can refer to a “Part A” process of file format checking and initial record and file validation, while Block 210 can refer to a “Part B” process of quality checking each record and file, or only those that satisfy the Part A format check.

At block 208 the process 200 includes evaluating a syntax of the record to determine whether the syntax is valid or invalid and assigning a corresponding syntax flag to the record. Syntax evaluation can include performing file formatting evaluations such as evaluating file format (e.g., CSV, XML, JSON, and the like), encoding formats, null field verification, malware detection and the like. Syntax validation focuses on non-semantic analysis of records. In response to determining the syntax of a given record is valid or invalid (e.g., for improper record or file format), the file parser 112 can assign a corresponding syntax flag to the record. In some examples, assigning an invalid syntax flag to a given record can terminate the appending process for that given record such that block 210 is not performed. In some examples, block 208 is performed prior to block 210, such that syntax evaluation is performed prior to content evaluation. However, by providing non-semantic analysis in syntax evaluation prior to more semantic-driven analysis in content evaluation per block 210, records with invalid syntax flags can be removed from additional appendix procedures of block 210 to conserve data processing expenditures.

At block 210 the process 200 includes evaluating content of the record to determine whether the content is ready for processing, and assigning a corresponding record ready flag comprising a record-valid flag or a record-error flag. According to additional examples discussed with respect to FIGS. 3A-3B, partially valid record ready flags may be set. Partially valid flags can lead to records being accepted, however, such records may prevent the full processing and resolution of associated accounts, such as for example, full processing per FDIC Rule 370. As an example of partially valid flag manipulation, an account with only some, but not all beneficiaries listed on a trust account instead of all eligible beneficiaries. Such records with missing beneficiary entries will not prevent processing such partial record. However, lacking the additional beneficiaries will not resolve the trust account to the last dollar or penny. In such cases, no soft or hard errors are present, but the data itself is partially complete as it fails to provide the fully accurate amount. As a result, a partially valid flag can be set to indicate a partial or pending record.

Block 210 refers to a quality check, semantic, level analysis of the record to evaluate record validity. The content of each record can include sets of entries, while the evaluation of the content of the record can include various configurable rules based on the entries In one example, a record can include entries related to FDIC Rule 370 compliance data such as broker number, account number (e.g., linking to a financial institute), customer account number (e.g., linking to a broker, third party organization, or other entity), committee on uniform securities identification procedures (CUSIP) identifiers, tax IDs, and the like. In the same example, the configurable rules for content evaluation of the record and its entries can include setting flags corresponding to whether a record's entries are null, or if the record's account number and customer account number entries are null. Based on the configurable rules and the corresponding flags, record-ready flags can be set indicative of whether the record or file to which it belongs is ready for further processing.

For example, record error flags can be set in response to one or more of: each of the broker number, securities CUSIP ID and customer account number are null, or each of the account number and customer account number are null. The availability of data in these fields indicates whether to determine each file as direct obligatory broker or non-direct obligatory broker, which in turn can determine the treatment of the entities including customer accounts for FDIC rule 370 purposes.

Additional examples of record-content evaluation are described with respect to FIGS. 3A-3B. s At block 212 the process 200 includes transmitting the appended merged file. Transmission can include transmission to client devices, or further internal computing systems and databases for subsequent storage and processing. For instance, the appended merged file can be transmitted to a distributed computing environment and data lake structure for subsequent processing. In an example of subsequent processing, the appended merged file can be ingested per a curation procedure where the constituent records, determined to be ready for processing per the appended merged file, are then processed without error. In the same or other examples, the appended merged file can be transmitted to an accepting entity to execute applicable rules such as the FDIC Rule 370 for customer account resolution in the event of bank failure.

### Example Process for Record Validation

FIGS. 3A and 3B show an example process for appending files and records within files to facilitate record validation, according to certain embodiments. For illustrative purposes, the process 300 is described with reference to implementations described above with respect to one or more examples described herein. Other implementations, however, are possible. In some aspects, the operations in FIGS. 3A and 3B may be implemented in program code that is executed by one or more computing devices such as the computing system 100 of FIG. 1. In some aspects of the present disclosure, one or more operations shown in FIGS. 3A and 3B may be omitted or performed in a different order. Similarly, additional operations not shown in FIGS. 3A and 3B may be performed.

FIGS. 3A and 3B show an example process 300 for record validation, providing expanded examples of means by which content of records is evaluated to determine whether a record is ready for processing, as initially discussed with respect to block 210 of FIG. 2. The process 300 is shown to include field level validation 301 techniques applied at a record 302 level, account level validation 311 techniques applied at a group of records 312 level, and partial file processing 321 analysis applied at a file 322 level. More or fewer operations can be applied according to various examples.

Field level validation 301 represents a record level analysis of a file. Generally, each file will contain a set of records for further analysis. Field level validation 301 is shown analyzing a record 302, where the record 302 belongs to a corresponding file or merged file. As discussed with respect to FIG. 2, each record 302 analyzed can include a set of entries, also referred to as fields. The field level validation 301 may be repeated for each record 302 in the original file and/or merged file.

The field level validation 301 includes analyzing each record's non-key fields (per block 304), key fields (per block 306), and additional key fields (per block 308). The process 300 includes identifying which entries within a record 302 are to be analyzed per a given validation procedure 304-308. Returning to the FDIC Rule 370 example, non-key fields can include Name fields (e.g., Name 1 and Name 2 fields), state fields, and individual retirement arrangement (IRA) codes. Key fields can include entity identifiers, such as customer keys, while additional key fields can include third party entity identifiers such as participant and beneficiary identifiers. In some examples, key field validation 306 can encompass additional field validation 308 such that additional field validation 308 is an optional procedure. According to other examples, additional field validation 308 can assign partial record ready flags, distinct from valid and invalid record ready flags assigned by key field validation 306, and thus is described separately according to the example of FIG. 3 for illustrative purposes.

Non-key field validation 304 can indicate the presence of soft-errors 310. Soft-errors refer to mis-entries (e.g., typos, null-values, non-readable data, data unable to be cross-referenced and the like) rendering the specific record incomplete even if still usable and capable of being processed. Once such data is identified in a non-key field per the non-key field validation procedure 304, soft-error 310 flags may be assigned to the record under analysis. Otherwise, non-key field validation 304 does not affect the ability to further process a record, and so the non-key field validation process includes setting a record ready flag to valid or invalid. The soft-error flag 310 can still be used for error tracking and user notification, such as to provide record and file owners the opportunity to overwrite or correct a file even if the record is capable of further processing.

Key field validation 306 includes identifying mis-entries within records rendering the specific entry or record non-usable and incapable of being further processed. Key field validation 306 can include a binary analysis including pass/fail analyses where the record ready flag may be set as valid if the record passes, or will be set as invalid the record fails the key field validation.

Additional field validation 308, like non-key field validation 304 and key field validation 306 includes a binary analysis for identifying whether a record or file is capable of further processing based on identified mis-entries in specified entries and fields of a given record. Unlike the other forms of validation, additional field validation indicates whether a file is capable of partial file processing. Some entries and records may be auxiliary, where the records do not need to be processed for the file to be fully processed, but in doing so, such auxiliary records would not be processed. Thus, setting partial validity record ready flags, based on identified mis-entries in specified fields, can indicate a file may be partially processed without the record with the partial validity record ready flag. Based on given client computing systems and file owner preferences, partial file processing may be enabled or disabled. When enabled, the partial validity record ready flag can allow for processing of a group of records, while when disabled, the partial validity record ready flag can function as a flag indicating the records are not ready for further processing.

For each of the soft-error flags, invalid record ready flags, and partial validity record ready flags, error codes can further be captured, identifying the specific field, entry, or rule that triggered the respective flag. For instance, an error code of “02” can indicate an account number is missing, triggering an invalid record ready flag, while an error code of “21” can indicate “Name” fields are missing, triggering soft-error flags. Assigning capture codes uniquely identifying the cause of a corresponding flag can then be used to alert clients and owners of a given record or file as to the cause of the flag. Additional description of such notifications is described with respect to FIG. 4.

Field level validation 301 may be performed for each record 302 in a file, merged file, or group of records. Records can be grouped based on file. Records can also be grouped based on owner, line of business, vendor, and the like. Thus, records across multiple files can be grouped together, depending on the configuration of records and files received by the computing system file reception service 108.

Account level validation 311 represents an account level, also referred to as group level, analysis of sets of files. Per the preceding field level validation 301, individual records may be set with corresponding flags. At the account level validation 311, records can have flags adjusted based on associated, grouped records. Such an approach allows for various files and corresponding owners to be notified of potential errors within records and files, allowing for review of the file, in addition to file and partial file processing procedures. Thus, account level occurs based on a group of records 312 level approach, where each record in the group of records 312 is assigned flags based on other individual records within the group of records 312.

At decision 314, the group of records 312 is analyzed to determine whether all records in the group of records 312 has a record ready flag set to valid. In response to determining all records in the group of records 312 have been assigned valid record ready flags, the record ready flags are retained as unmodified, and each record of the group of records 312 is indicated as ready for further processing. Otherwise, the flow proceeds to decision 316.

At decision 316, the group of records 312 is analyzed to determine whether all records in the group of records 312 have a valid record ready flag or a partial validity record ready flag. In response to determining all records in the group of records 312 have a valid record ready flag or a partial validity record ready flag, all record ready flags set to partial validity record ready flags, while the partial validity record ready flags are retained as unmodified, and each record of the group of records 312 is indicated as ready partial file processing. Otherwise, the flow proceeds to decision 318.

At decision 318, the group of records 312 is analyzed to determine whether any records in the group of records 312 has a record invalid flag. In response to determining a single record in the group of records 312 has an invalid record ready flag, all records in the group of records 312 are assigned the invalid record ready flag.

FIG. 3B shows a continuation of the merged file appending process 300 discussed with respect to FIG. 3A. In FIG. 3B, a partial file processing procedure 321 is shown to illustrate application of partial file processing flags set per the additional field validation 308 procedure of FIG. 3A.

The partial file processing 321 procedure is shown to occur at a file 322 level. Each file 322 within a merged file includes a set of records analyzed per the process 300, discussed with respect to FIG. 3A. Because some client devices, vendors, customers and the like, may not allow or partial file processing, partial file processing 321 procedure can update record ready and file ready flags responsive to the capabilities and requirements of the client devices, vendors, and customers.

At decision 324, the process 300 includes determining whether the client supports partial file processing 324. The determination can be made based on messages transmitted the computing system, or from data stored in a client repository indicating information associated with each client, such as the files and records they own. In response to determining the client does not support partial file processing, the process 300 processed to block 326, otherwise the process 300 proceeds to blocks 328 and 330.

At block 326, in response to determining the client does support partial file processing, the record validation service 114 can evaluate each record in the file based on record ready flags (such assignments discussed with respect to FIG. 3A). If any records in the file have a record ready flag set to invalid, then a file ready flag can be set to false for all records within the file.

At blocks 328 and 330, response to determining the client does not support partial file processing, the computing system 100 can similarly evaluate each record in the file based on record ready flags. Blocks 328 and 330 represent flag setting operations allowing for the partial file processing of a given file, where flags corresponding records are individually set. At block 328, for records that have a record ready flag set or a partial record ready flag set, the corresponding records may then have a file ready flag set, indicating that such records, as part of the file are ready for further processing per a partial file processing procedure. At block 330, for each record that has a record not ready flag set, or a record ready flag set to false, the corresponding records may then have a file not ready flag set, or a file ready flag set to false.

### Example Process for Record Quarantine and Remediation

Per FIGS. 2 and 3A-3B, when various flags are set, such as soft-error flags, partial file ready flags and valid/invalid record ready flags are assigned, clients and owners of the various records may wish to access the files and records with such flags in order to override and cure deficiencies within the flagged improper files and records. FIG. 4 shows an example process for quarantining and remedying improper records, according to certain embodiments. For illustrative purposes, the process 400 is described with reference to implementations described above with respect to one or more examples described herein. Other implementations, however, are possible. In some aspects, the operations in FIG. 4 may be implemented in program code that is executed by one or more computing devices such as the computing system 100 of FIG. 1. In some aspects of the present disclosure, one or more operations shown in FIG. 4 may be omitted or performed in a different order. Similarly, additional operations not shown in FIG. 4 may be performed.

At block 402 the process 400 includes generating an appended merged file. Block 402 is similar to block 206 of FIG. 2. Block 402 is included to illustrate additional techniques contemplated by the processes 200 and 300 described with respect to FIGS. 2 and 3A-3B. The process 400, relying on flags and alerts generated per the preceding processes 200 and 300 thus incorporates some of the operations discussed with respect to processes 200 and 300.

At block 404 the process 400 includes determining whether the record includes an invalid syntax flag or a record-error flag. Invalid syntax flags can be generated per block 208 of process 200, while record-error flags, including soft-error flags, invalid record ready flags, and partially valid record ready flags, can be generated per block 210 of process 200, as further described with respect to process 300.

At block 406 the process 400 includes, optionally, storing the record in a quarantine repository, also referred to as an error log. The quarantine/error log provides a repository for each identified improper record and file to be evaluated by interested parties such as file owners, vendors, regulators, and the like. In some cases the records and files identified as invalid or otherwise incomplete are transmitted to the quarantine repository, and in other cases duplicated into the quarantine repository, or otherwise stored as pointers within the quarantine repository. Generally, the quarantine repository provides a consolidated location for associated users to review records and files identified as incomplete and invalid, and be provided an opportunity for overriding the files and records, as discussed with respect to blocks 408-410. The records stored in the quarantine repository can be stored with the corresponding error codes to facilitate direct identification of the root cause of a given flag.

At block 408 the process 400 includes generating a signal associated with an alert indicating one or more records in the quarantine repository. The alert can include a summary of errors and can serve as a notification to an entity associated with the record or file. Error codes, helping link given records and files to specific errors, can be retrieved from the a database based on the alert notification. For example, entities receiving the alert can include relevant lines of business, regulators, or any other party requiring an opportunity to override an invalid, incorrect file. In some examples, alerts are generated in real-time or near-real time, where the alerts are generated in immediate response to when a record or file is identified flagged with a soft-error or other flag. In other examples, alerts may be configured as periodic, where such alerts report, to associated entities and client devices, the flagged records and files per time-based snapshots of the quarantine repository.

At block 410 the process 400 includes receiving a modified record corresponding to a selected record including an invalid syntax flag or record-error flag. The modified record may be received from the device to which the alert was transmitted. The modified record represents override capabilities granted to identified entities and client devices. The received modifications can include modifications to individual files, or to full records. Modifications can include full file replacements of a given file, or the deletion of the file at issue, allowing file owners the opportunity to skip the processing of an identified file. Such override capabilities allow for partial file processing, full file processing, or selected segments (e.g., a subset of records) within the file.

At block 412 the process 400 includes overwriting an entry within the selected record with an entry in the modified record. Generally, overwriting capabilities refer to a record or file level replacement, can include, at the most granular level, modification to a given entry within a record, the record within the file. Returning to the FDIC Rule 370 example, a soft-error flagging indicating a “State” entry within a given record is null can lead to a record, and the file to which it belongs, being flagged with a soft-error. The opportunity to override the incorrect “State” entry may only necessitate adjustment of the single “State” entry within the record. Thus, at a minimum, the “State” entry can be overwritten and overridden, while not requiring full replacement of the full record or the full file. Otherwise, replacement of the record or of the file would still constitute overwriting the entry within the selected record with an entry in a modified record (e.g., a non-null “State” value).

### Example Process for Merging Records to Allow for Record Exception Handling

The content evaluation and record validation procedures discussed with respect to FIGS. 2 and 3A-3B represent file intensive processes which can involve instantiating read and write access of thousands of files. To reduce burden on processing capabilities of the computing system 100 and to improve time efficiencies in the record validation process, some examples include performing a merge operation for sets of files to generate a merged file. Processing the merged file per the pre-curation service 110 as opposed to individual processing of the constituent files can thus resolve computer-centric issues of minimizing file access operations and processor burden.

FIG. 5 shows an example process for merging files, allowing for record exception handling, according to certain embodiments. For illustrative purposes, the process 500 is described with reference to implementations described above with respect to one or more examples described herein. Other implementations, however, are possible. In some aspects, the operations in FIG. 3 may be implemented in program code that is executed by one or more computing devices such as the computing system 100 of FIG. 1. In some aspects of the present disclosure, one or more operations shown in FIG. 5 may be omitted or performed in a different order. Similarly, additional operations not shown in FIG. 5 may be performed.

At block 502 the process 500 includes merging each file of the set of files into a merged file. Block 502 is similar to block 204 of process 200. In some examples, block 502 illustrates additional processes per block 204 that can be incorporated into process 200.

At block 504 the process 500 includes generating and assigning the file identifier flags to a corresponding record. File identifier flags can indicate the file (e.g., those received at block 202) to which a given record belongs. Thus, despite merging files and corresponding records together, the records can maintain linkage to their parent files, pre-merge. Such tracking can allow for identification of improper files and other files requiring remediation based on record ready flags and other identifiers applied to a given record (e.g., discussed with respect to record validation service 114 operations of process 300).

At block 506 the process 500 includes grouping each record into a file group based on the file identifier flag. By grouping the records together based on file, file ready flags can be assigned to the set of records based on other records within the file group (e.g., as discussed with respect to partial file processing 321 of FIG. 3B). In addition or alternatively, records can be grouped based on account identifiers (e.g., as discussed with respect to account level validation 311 of FIG. 3A), where records within the account identifier group may then be manipulated based on flags of other records within the account identifier group.

At block 508 the process 500 includes identifying a recipient of the appended merged file. Recipients of the appended merged file can include various client computing systems or other entities with access to the computing system 100. Based on messages received from the recipient or based on client data within the computing system, the recipient may be identified as capable or not capable of performing partial file processing.

At block 510 the process 500 includes, for each file group, in response to determining the recipient does not support partial file processing, and in response to identifying a file in the file group has a record error flag, assigning each record in the file group the record error flag. Additional operations for assigning record and file error flags based on grouped files are discussed with respect to process 300.

### Example Computing Environment for Alternate Record Exception Handling

Any suitable computing system or group of computing systems can be used for performing the operations described herein. For example, FIG. 6 shows a block diagram for a computing environment 600 capable of executing the described systems and methods, according to certain examples.

The depicted example of a computing system 602 includes one or more processors 606 communicatively coupled to one or more memory devices 604. The processor 606 executes computer-executable program code or accesses information stored in the memory device 604. Examples of processor 606 include a microprocessor, an application-specific integrated circuit (“ASIC”), a field-programmable gate array (“FPGA”), or other suitable processing device. The processor 606 can include any number of processing devices, including one.

The memory device 604 includes any suitable non-transitory computer readable medium for storing file reception service 622, pre-curation service 624, alert generation unit 626, and other dynamic instructions 628 or received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 602 may also include a number of external or internal devices such as input or output devices. For example, the computing system 602 is shown with an input/output (“I/O”) interface 610 that can receive input from input devices or provide output to output devices. A bus 608 can also be included in the computing system 602. The bus 608 can communicatively couple one or more components of the computing system 602.

The computing system 602 executes program code that configures the processor 606 to perform one or more of the operations described above with respect to FIGS. 1-5. The program code includes operations related to, for example, receiving and ingesting data files, generating metadata associated with the data files, and determining access to the data files, or other suitable applications or memory structures that perform one or more operations described herein. The program code may be resident in the memory device 604 or any suitable non-transitory computer-readable medium and may be executed by the processor 606 or any other suitable processor. In some embodiments, the program code described above, including file reception service 622, pre-curation service 624, alert generation unit 626, and other dynamic instructions 628 or received or determined values or data objects are stored in the memory device 604, as depicted in FIG. 6. In additional or alternative embodiments, one or more of the file reception service 622, pre-curation service 624, alert generation unit 626, and other dynamic instructions 628 or received or determined values or data objects described above are stored in one or more memory devices accessible via a data network, such as a memory device accessible via a cloud service.

The computing system 602 depicted in FIG. 6 also includes at least one network interface 612. The network interface 612 includes any device or group of devices suitable for establishing a wired or wireless data connection to one or more data networks 614 such as viewing applications 620 including user interfaces. Non-limiting examples of the network interface 612 include an Ethernet network adapter, a modem, and/or the like. A remote communication service 618 is connected to the computing system 602 via network 614 and can perform some of the operations described herein including generating templates or receiving messaging data and applying the messaging data to a specified template. The computing system 602 is able to communicate with one or more of the remote communication service 618 and data sources 616. Data sources 616 can include a data repository, for instance, in examples where the computing system 602 performs the processes within the file reception service 622, pre-curation service 624, and alert generation unit 626. In other examples, one or more of a data repository and/or quarantine repository 120 can be stored within the computing system 602 such that transmission across network 614 is not necessary.

### Advantages of Systems and Methods for Alternate Record Exception Handling

The described systems and methods provide improvements record access by providing real time data standardization and opportunities for record validation. For various reasons, records may be required to be received in a variety of formats by central servers and computing systems. For instance, certain third party services and other data providers may provide records in a variety of formats due to such parties'hardware and software computing environment requirements or preferences. Additionally, regulations, such as FDIC Rule 370, may require files and records to be received in a variety of formats, while subsequently stored in manners indicated by additional regulations.

It can be difficult to manage records received in various formats, and such issues are compounded when the received records are invalid on upload or reception. To resolve such issues, the described techniques address collecting, converting, merging, and analyzing records from various third parties. An appended merged file, generated by a pre-curation service, can include flagged errors for given records and files. The described system and methods can provide alerts and notifications to allow for overriding improper files and thus prevent further processing of such files which risks halting, crashing, or otherwise inhibiting the efficiency of other programs within a computing network. Automatic messages and immediate messaging to client entities to remediate data formatting issues in received files can further streamline computing efficiency.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method comprising:
receiving a set of files, each file of the set of files including a set of records;
merging each file of the set of files into a merged file comprising the sets of records;
generating an appended merged file, by, for each record in the merged file:
evaluating a syntax of the record to determine whether the syntax is valid or invalid and assigning a corresponding syntax flag to the record;
evaluating content of the record to determine whether the content is ready for processing and assigning a corresponding record ready flag comprising a record-valid flag or a record-error flag; and
transmitting the appended merged file.

2. The method of claim 1, further comprising:
storing in a quarantine repository, each record including an invalid syntax flag or a record-error flag; and
generating a signal associated with an alert indicating one or more records in the quarantine repository.

3. The method of claim 2, further comprising:
receiving a modified record corresponding to a selected record including an invalid syntax flag or record-error flag; and
overwriting an entry within the selected record with an entry in the modified record.

4. The method of claim 1, wherein merging each file of the set of files includes, for each file of the set of files, generating a file identifier flag, and assigning the file identifier flag to a corresponding record.

5. The method of claim 4, further comprising:
grouping each record into a file group based on the file identifier flag;
identifying a recipient of the appended merged file; and
for each file group:
in response to determining the recipient does not support partial file processing, and in response to identifying a file in the file group has a record error flag, assigning each record in the file group the record error flag.

6. The method of claim 1, wherein each record of the set of records includes a set of entries, and wherein evaluating content of the record comprises:
identifying, for each entry of the set of entries, a corresponding field, the corresponding field including a non-key field or a key field;
for each entry with a corresponding key field, validating the corresponding key field; and in response to determining the corresponding key field is invalid, assigning a record-error flag to a corresponding record.

7. The method of claim 6, further comprising for each entry with a corresponding non-key field, validating the corresponding non-key field; and
in response to determining the corresponding key field is invalid, assigning a soft-error flag to the corresponding record.

8. The method of claim 6, wherein the set of entries for each file includes one or more of: a broker number, Securities (CUSIP) ID, account number, or customer account number.

9. The method of claim 8 wherein validating the corresponding key field includes assigning a record error flag to the corresponding record in response to determining one or more of: each of the broker number, CUSIP ID and customer account number are null, or each of the account number and customer account number are null.

10. A system comprising:
one or more processors configured to:
receive a set of files, each file of the set of files including a set of records;
merging each file of the set of files into a merged file comprising the sets of records;
generate an appended merged file by, for each record in the merged file:
evaluating a syntax of the record to determine whether the syntax is valid or invalid and assigning a corresponding syntax flag to the record;
evaluating content of the record to determine whether the content is ready for processing and assigning a corresponding record ready flag comprising a record-valid flag or a record-error flag; and
transmit the appended merged file.

11. The system of claim 10, wherein the one or more processors are further configured to:
store in a quarantine repository, each record including an invalid syntax flag or a record-error flag; and
generate a signal associated with an alert indicating one or more records in the quarantine repository.

12. The system of claim 10, wherein the one or more processors are further configured to:
receive a modified record corresponding to a selected record including an invalid syntax flag or record-error flag; and
overwrite an entry within the selected record with an entry in the modified record.

13. The system of claim 10, wherein merging each file of the set of files includes for each file of the set of files, generating a file identifier flag, and assigning the file identifier flag to a corresponding record.

14. The system of claim 13, wherein the one or more processors are further configured to:
group each record into a file group based on the file identifier flag;
identify a recipient of the appended merged file; and
for each file group:
in response to determining the recipient does not support partial file processing, and in response to identifying a file in the file group has a record error flag, assign each record in the file group the record error flag.

15. The system of claim 10, wherein each record of the set of records includes a set of entries, and wherein evaluating content of the record comprises:
identifying, for each entry of the set of entries, a corresponding field, the corresponding field including a non-key field or a key field;
for each entry with a corresponding key field, validating the corresponding key field; and in response to determining the corresponding key field is invalid, assigning a record-error flag to a corresponding record.

16. The system of claim 15, wherein the one or more processors are further configured to:
for each entry with a corresponding non-key field, validate the corresponding non-key field; and
in response to determining the corresponding key field is invalid, assign a soft-error flag to the corresponding record.

17. The system of claim 15, wherein the set of entries for each file includes one or more of: a broker number, Customer (CUSIP) ID, account number, or customer account number.

18. The system of claim 17, wherein validating the corresponding key field includes assigning a record error flag to the corresponding record in response to determining one or more of: each of the broker number, CUSIP ID and customer account number are null, or each of the account number and customer account number are null.

19. A non-transitory computer readable medium comprising instructions that, when executed by one or more processors, cause the one or more processors to:
receive a set of files, each file of the set of files including a set of records;
merging each file of the set of files into a merged file comprising the sets of records;
generate an appended merged file by, for each record in the merged file:
evaluating a syntax of the record to determine whether the syntax is valid or invalid and assigning a corresponding syntax flag to the record;
evaluating content of the record to determine whether the content is ready for processing and assigning a corresponding record ready flag comprising a record-valid flag or a record-error flag; and
transmit the appended merged file.

20. The non-transitory computer readable medium of claim 19, wherein the one or more processors are further configured to:
store in a quarantine repository, each record including an invalid syntax flag or a record-error flag; and
generate a signal associated with an alert indicating one or more records in the quarantine repository.
